(19) United States
(12) Patent Application Publication
(10) Pub. No.: US 2022/0328799 A1
(43) Pub. Date: Oct. 13, 2022

(54) DRY PROCESS FOR FORMING AN ELECTRODE

(71) Applicant: Livent USA Corp., Philadelphia, PA (US)

(72) Inventors: Jian Xia, Belmont, NC (US); Kenneth Brian Fitch, Cherryville, NC (US); Marina Yakovleva, Gastonia, NC (US); Rebecca N. Black, Charlotte, NC (US)

(73) Assignee: Livent USA Corp., Philadelphia, PA (US)

(21) Appl. No.: 17/702,154

(22) Filed: Mar. 23, 2022

Related U.S. Application Data
(60) Provisional application No. 63/172,274, filed on Apr. 8, 2021.
(60) Provisional application No. 63/273,287, filed on Oct. 29, 2021.

(51) Int. Cl. H01M 4/04; H01M 4/583; H01M 4/134; H01M 10/0525; H01M 4/38; H01M 4/62

(52) U.S. Cl. CPC H01M 4/0404; H01M 4/0435; H01M 4/583; H01M 4/134; H01M 10/0525; H01M 4/386; H01M 4/622

(57) ABSTRACT

A one-step and dry process for forming an electrode is provided. The process may include dry mixing an active component having an active electrode material, a binder and a conductive material with a prelithiation agent to form a dry electrode material mixture. The prelithiating agent may be a printable lithium composition and may include a lithium metal powder, a polymer binder compatible with the lithium metal powder, and a rheology modifier compatible with the lithium metal powder. The dry electrode material mixture is applied to a substrate as a non self-supporting layer to form the electrode.

### RELATED APPLICATION

The present application relates to U.S. Provisional Application Nos. 63/172,274 filed Apr. 8, 2021 and 63/273,287 filed Oct. 29, 2021, the disclosure of which are hereby incorporated by reference in their entireties.

### FIELD OF THE INVENTION

The present invention relates to processes for forming electrodes in a single processing step and provides dry processes for forming electrodes, namely the use of solvents is essentially or substantially eliminated.

### BACKGROUND OF THE INVENTION

Lithium and lithium-ion secondary or rechargeable batteries have found use in certain applications such as in cellular phones, camcorders, and laptop computers, and even more recently, in larger power application such as in electric vehicles and hybrid electric vehicles. It is preferred in these applications that the secondary batteries have the highest specific capacity possible but still provide safe operating conditions and good cyclability so that the high specific capacity is maintained in subsequent recharging and discharging cycles.

Although there are various constructions for secondary batteries, each construction includes a positive electrode (or cathode), a negative electrode (or anode), a separator that separates the cathode and anode, an electrolyte in electrochemical communication with the cathode and anode. For secondary lithium batteries, lithium ions are transferred from the anode to the cathode through the electrolyte when the secondary battery is being discharged, i.e., used for its specific application. During the discharge process, electrons are collected from the anode and pass to the cathode through an external circuit. When the secondary battery is being charged, or recharged, the lithium ions are transferred from the cathode to the anode through the electrolyte.

New lithium-ion cells or batteries are initially in a discharged state. During the first charge of lithium-ion cell, lithium moves from the cathode material to the anode active material (e.g. graphite). The lithium moving from the cathode to the anode reacts with an electrolyte material at the surface of the graphite anode, causing the formation of a passivation interface on the anode. The passivation interface formed on the graphite anode is also called a solid electrolyte interface (SEI). Upon subsequent discharge, the lithium consumed by the formation of the SEI is not returned to the cathode. This results in a lithium-ion cell having a smaller capacity compared to the initial charge capacity because some of the lithium has been consumed by the formation of the SEI. The partial consumption of the available lithium on the first cycle reduces the capacity of the lithium-ion cell. This phenomenon is called irreversible capacity loss and is known to consume about 10% to more than 20% of the capacity of a lithium ion cell. Thus, after the initial charge of a lithium-ion cell, the lithium-ion cell undesirably loses about 10% to more than 20% of its capacity.

One solution has been to use stabilized lithium metal powder to pre-lithiate the anode. For example, lithium powder can be stabilized by passivating the metal powder surface with carbon dioxide such as described in U.S. Pat. Nos. 5,567,474, 5,776,369, and 5,976,403, the disclosures of which are incorporated herein in their entireties by reference. The CO₂ passivated lithium metal powder may not be ideal because it can be used only in air with low moisture levels for a limited period of time before the lithium metal content decays because of the reaction of the lithium metal and air. Another solution is to apply a coating such as fluorine, wax, phosphorus or a polymer to the lithium metal powder such as described in U.S. Pat. Nos. 7,588,623, 8,021,496, 8,377,236 and U.S. Patent Publication No. 2017/0149052, the disclosure of which are incorporated by reference in their entireties, for example. These coatings provide higher stability to the lithium powder in a dry room environment.

Another solution is to use lithium foil. When lithium foil is used for pre-lithiation and directly laminated to the surface of the electrode, as a result of “short circuit” lithiation due to the lamination pressure applied, potentially, significant heat may be generated. When this pre-lithiation technique is performed in a roll to roll process, heat may build up in the center of the roll and might be difficult to dissipate. This heat buildup can potentially lead to for example, mechanical damage of the electrode and more importantly, to potential thermal runaway.

Another known battery issue is lithium plating, which commonly occurs during fast charging when lithium deposits, called dendrites, accumulate on the electrode surface potentially leading to short circuiting and failure of the battery. Lithium plating occurs at low voltages or low temperatures and in parallel with Li⁺ ion intercalation into the anode [Proc. Natl Acad. Sci. USA 115, 7266-7271 (2018)]. To improve the kinetics of Li⁺ ion intercalation, lower charge transfer resistance is preferred. To increase charging rates, researchers have focused on improving materials' conductivities. For example, U.S. Pat. No. 7,037,581B2, incorporated herein by reference in its entirety, describes the synthesis of a conductive silicon composite in which particles of the structure that silicon crystallites are dispersed in silicon dioxide are coated with carbon resulting in satisfactory cycle performance. US Publication No. 2019/0148774, incorporated herein by reference in its entirety, describes improvements in fast charging lithium ion batteries through the use of less viscous electrolytes components, such as an ester. However, all these methods have trade-offs and it is very difficult to improve fast charging properties while maintaining safety and energy density.

Electrodes are typically formed from a slurry and may consist of active materials, binder, conductive materials as well as solvents. N-Methyl-2-pyrrolidone (NMP) is the most commonly used solvent for cathode slurry while water is becoming more widely used for graphite-based anode slurry. NMP has a high boiling point (202° C.) and thus the removal of NMP requires significant energy consumption. Moreover, NMP is reactive with lithium, may be toxic and requires a solvent recovery system to reduce potential environmental hazards, further adding costs to the battery electrode fabrication process. Water-based approaches are more environmentally friendly and eliminates the need of solvent recovery systems. Several research groups have shown that electrodes made using water-based approaches can achieve similar performance to electrodes made using an NMP-based approach [Electrochim Acta 114 (2013), 1-6]. However, water-based slurries have poor wettability as well as causing corrosion of the current collector. In both cases, a high temperature oven and long drying times are needed, increasing manufacturing costs and lowering production throughput.

Manufacturing processes with lower solvent usage have been achieved through pulsed-laser deposition, electrostatic spraying deposition (ESD) as well as tribo-charging gun processes. For example, Ludwig et al. [Adv. Mater. Interfaces 2017, 4, 1700570] reported the use of ESD, followed by a hot-rolling treatment, to create a 40-130 mm thick cathode containing a 90:5:5 ratio of LCO:carbon additive:PVDF with about 30% porosity, which delivers a specific capacity of 121 mAh g-1 at a charge rate of 0.1 C.

However, existing dry methods for electrode production require multiple steps that reduce efficiency. For example, U.S. Pat. No. 10,547,057, the disclosure of which is herein incorporated by reference in its entirety, discloses a method for producing electrodes that requires that a stand-alone film to be produced before laminating onto a current collector. Moreover, current dry methods of forming electrodes require using a high temperature process above the melting point of lithium metal, namely above 180.5° C. When using such high temperatures and also high pressure, mechanical lithiation of the anode active materials can occur creating unstable or pyrophoric reaction products (for example, lithiated silicon or graphite) and thus preclude the production of prelithiated dry electrodes in a single processing step.

### SUMMARY OF THE INVENTION

To this end, the present invention is directed to a one-step and dry process for forming electrodes that essentially or substantially eliminates the use of solvent, particularly solvents that are reactive with lithium, while incorporating a prelithiating agent. No additional solvent may be necessary except for what is present in the prelithiation agent. The process also enables one step advanced electrode production in which irreversible capacity may be eliminated. A stand-alone self-supported film or foil does not need to be formed first then laminated to the substrate (e.g., current collector or a pretreated current collector) in a separate step. The dry electrode material layer or interface may be applied to the substrate as a non self-supported layer.

In one embodiment, the electrode is formed using a one-step and dry process. The process may comprise preparing a dry active material comprising an active component comprising an active electrode material, a binder and a conductive material mixed with a prelithiation agent such as a printable lithium composition to form a dry electrode material mixture. The printable lithium composition may include a lithium metal powder, a polymer binder compatible with the lithium metal powder, and a rheology modifier compatible with the lithium metal powder, and may be essentially solvent free. The dry electrode material mixture may be applied to a substrate to form the electrode. The dry electrode material mixture may be applied to the substrate by directly depositing the dry electrode material mixture onto the substrate as a layer or interface without the need to form a standalone film or foil and with minimum use of a solvent i.e., the process is essentially solvent free. The dry electrode material mixture may then be pressed onto the substrate to form the prelithiated electrode, for example using a roll to roll process.

Other features and aspects of the invention will be apparent from the following Detailed Description, the drawings and the claims.

### BRIEF DESCRIPTION OF THE DRAWINGS

FIG. 1 is a schematic diagram of an exemplary process according to an embodiment of the invention.

FIG. 2 is a plot comparing the 1st cycle voltage curve of a baseline cell versus a cell with an electrode incorporating printable lithium composition, both formed using dry electrode process according to Example 1.

FIG. 3 is a plot comparing the voltage curve of a baseline cell versus a cell with printable lithium composition incorporated according to Example 1.

FIG. 4 is a plot comparing differential capacity (dQ/dV) versus potential (V) during first charge between baseline and cells with a printable lithium composition incorporated according to Example 1.

FIG. 5 is a plot comparing differential capacity (dQ/dV) versus potential (V) during first charge between baseline and cells with a printable lithium composition incorporated according to Example 2.

FIG. 6 is a plot comparing differential capacity (dQ/dV) versus potential (V) during first charge between baseline and cells with a printable lithium composition incorporated according to Example 3.

FIG. 7 is a plot comparing the voltage curve of a baseline cell versus a cell with an electrode incorporating printable lithium composition according to Example 4.

FIG. 8 is a plot comparing differential capacity (dQ/dV) versus potential (V) during first charge between baseline and cells with a printable lithium composition incorporated according to Example 4.

### DETAILED DESCRIPTION

The foregoing and other aspects of the present invention will now be described in more detail with respect to the description and methodologies provided herein. It should be appreciated that the invention can be embodied in different forms and should not be construed as limited to the embodiments set forth herein. Rather, these embodiments are provided so that this disclosure will be thorough and complete, and will fully convey the scope of the invention to those skilled in the art.

The terminology used in the description of the invention herein is for the purpose of describing particular embodiments only and is not intended to be limiting of the invention. As used in the description of the embodiments of the invention and the appended claims, the singular forms “a”, “an” and “the” are intended to include the plural forms as well, unless the context clearly indicates otherwise. Also, as used herein, “and/or” refers to and encompasses any and all possible combinations of one or more of the associated listed items.

The term “about,” as used herein when referring to a measurable value such as an amount of a compound, dose, time, temperature, and the like, is meant to encompass variations of 20%, 10%, 5%, 1%, 0.5% or even 0.1% of the specified amount. Unless otherwise defined, all terms, including technical and scientific terms used in the description, have the same meaning as commonly understood by one of ordinary skill in the art to which this invention belongs.

As used herein, the terms “comprise,” “comprises,” “comprising,” “include,” “includes” and “including” specify the presence of stated features, integers, steps, operations, elements, and/or components, but do not preclude the presence or addition of one or more other features, integers, steps, operations, elements, components, and/or groups thereof.

As used herein, the term “consists essentially of” (and grammatical variants thereof), as applied to the compositions and methods of the present invention, means that the compositions/methods may contain additional components so long as the additional components do not materially alter the composition/method. The term “materially alter,” as applied to a composition/method, refers to an increase or decrease in the effectiveness of the composition/method of at least about 20% or more.

All patents, patent applications and publications referred throughout the specification are incorporated by reference in their entirety. In case of a conflict in terminology, the present specification is controlling.

In accordance with the present invention, a process for forming an electrode is provided. The process comprises dry mixing an active component comprising an active electrode material, a binder and a conductive material with a prelithiation agent such as a printable lithium composition comprising a lithium metal powder, a polymer binder compatible with the lithium metal powder, and a rheology modifier compatible with the lithium metal powder to form a dry electrode material mixture. Dry mixing is intended to mean that essentially or substantially no solvent or an essentially or substantially low amount of solvent is used in the mixing process. In one embodiment, the only solvent present is from the prelithiation agent.

The dry electrode material mixture may then be applied to a substrate to form the electrode as a non self-supporting layer or interface. A non self-supporting layer or interface is a layer or interface or coating that cannot standalone and is in contrast to a standalone film or foil.

The substrate may be a substrate for an anode (e.g., a current collector), a cathode or a solid electrolyte for a solid-state battery. Batteries having a cathode and an anode formed from the process may have a first cycle efficiency greater than about 80%, and in some instances, may be greater than 90%.

Dry mixing may be carried out using conventional techniques known in the art. For example, dry mixing may be performed with high sear mixers, planetary mixers, ribbon mixers, drum mixers, screw mixers, conical mixers, multi-shaft mixers and static mixers.

The dry electrode material mixture may be applied to the substrate using a variety of techniques. For example, the dry electrode material mixture may be deposited onto the substrate as a non self-supported layer using a dry powder application technique. Common examples of methods for depositing dry powder are disclosed in US Publication No. 2021/0050584 incorporated herein by reference in its entirety. Methods for depositing the dry electrode material mixture to the substrate may include sieving, spraying, extruding, roll compaction, electrostatic deposition and combinations thereof. The deposited dry electrode material mixture may then be pressed onto the substrate; for example, at a temperature between about 80 and 180° C. and at a pressure between about 500 and 50000 PSI.

In one embodiment, the substrate may be a current collector such as a foil, film mesh or foam of copper, nickel, zing, aluminum, silver, graphene and the like with or without a coating (e.g., a polymer coating such as polyisobutylene).

In another embodiment, the substrate may be for a solid electrolyte for a solid-state battery. For example, exemplary solid electrolytes may include polymer films derived from polystyrene, polyethylene, polyethylene oxide, polyester, polyvinylidene fluoride, polypropylene and the like. In another embodiment, the solid electrolyte may be a ceramic in the form of oxides, sulfides and phosphates.

In some embodiments, the active material may be mixed with a prelithiation agent such as a printable lithium composition as described in U.S. application Ser. Nos. 16/359,707 and 16/573,587, which are incorporated herein by reference in their entireties. The printable lithium composition may comprise a lithium metal powder, a polymer binder, a rheology modifier and may or may not further include a solvent.

In some embodiments, the dry electrode material mixture may contain no solvents, particularly solvents that are reactive to lithium. Exemplary solvents that are reactive with lithium and are to be avoided are polar solvents such as N-methyl 1,2 pyrrolidone (NMP) and gamma-butyrolactone (GBL). For example, the active material may be mixed with a the prelithiation agent (printable lithium composition) without additional solvent namely the prelithiation agent is essentially free of solvent. In some embodiments, the resulting dry electrode material mixture may be formed from the printable lithium composition may include a solvent that is mixed with a dry active material. The amount of solvent in the printable lithium composition may depend on properties of the active material (e.g., silicon content or irreversible capacity) and the amount of lithium metal powder in the printable formulation. Thus the amount of solvent may be controlled.

As shown in Table 1, the solvent ratio (weight %) in the dry electrode material mixture may vary and be controlled based on the amount of the lithium powder present in the prelithiation agent of the dry electrode mixture and the active material.

TABLE 1

| | Prelithiation Agent | | Active Material |
|---|---|---|---|
| | w/10% Lithium | w/30% Lithium | Irreversible |
| | Powder | Powder | Capacity (%) |
| Graphite Anode | Up to 11% | Up to 3% | 8-10% |
| Graphite/10% | Up to 14% | Up to 4% | 15-25% |
| SiO Anode | | | |

The higher the Si content, more lithium metal powder in the printable lithium composition is needed to compensate the lithium loss, and thus may have a need for more solvent in the printable lithium material that will be introduced into the mixture. Conversely, the higher the lithium metal powder content in the printable composition, the less printable lithium composition is needed and less solvent is needed. In these embodiments, the resulting dry electrode mixture may have a solvent content from the printable lithium composition of less than about 20 percent, often less than about 10 percent, sometimes less than about 1 percent, and may be essentially or substantially solvent free. It is to be recognized that the solvent in this embodiment will evaporate during the application process. Thus the dry electrode mixture, once it is applied to the substrate (e.g., current collector), may have less than 1 percent, often less than 0.5 percent and preferably about 0 percent and essentially free of solvent.

In some embodiments, the substrate may be treated with an adhesion promoting agent, e.g., as a polymer coating. Examples of adhesion promoters may include unsaturated elastomers, saturated elastomers, thermoplastics, polyacrylic acid, polyvinylidene chloride, and polyvinyl acetate. poly(ethylene oxide), polystyrene, polyisobutylene, natural rubbers, butadiene rubbers, styrene-butadiene rubber, polyisoprene rubbers, butyl rubbers, hydrogenated nitrile butadiene rubbers, epichlorohydrin rubbers, acrylate rubbers, silicon rubbers, nitrile rubbers, polyacrylic acid, polyvinylidene chloride, polyvinyl acetate, ethylene propylene diene termonomer, ethylene vinyl acetate copolymer, ethylene-propylene copolymers, ethylene-propylene terpolymers, polybutenes, wax and combinations thereof.

In one embodiment, exemplary active electrode materials for the active component may include active anode material such as graphite, carbon black, hard carbon, carbon alloys and combinations thereof. Alternatively, the active anode material may be graphite-SiOx composites, SiO, SiO₂, Si powder, SiC, SiC composites, Si-based alloys, graphite-SNO, SN C Composites and combinations thereof.

In another embodiment, the active electrode material may be an active cathode material that may be lithiated such as non-lithiated materials including MnO₂, V₂O₅, MoS₂, metal fluorides, sulfur, sulfur composites, tin and combinations thereof. However, lithiated materials such as LiMn₂O₄ and LiMO₂ wherein M is Ni, Co or Mn that can be further lithiated may also be used. The non-lithiated active materials are preferred because they generally have higher specific capacities, lower cost and broader choice of cathode materials in this construction that can provide increased energy and power over conventional secondary batteries that include lithiated active materials.

In some embodiments, the lithium metal powder may be in the form of a finely divided powder. The lithium metal powder typically has a medium particle size of less than about 80 microns, often less than about 40 microns and sometimes less than about 20 microns. The lithium metal powder may be non-pyrophoric stabilized lithium metal power (SLMP®) available from Livent USA Corp. The lithium metal powder may also include a substantially continuous layer or coating of fluorine, wax, phosphorus or a polymer or the combination thereof (as disclosed in U.S. Pat. Nos. 5,567,474, 5,776,369, and 5,976,403 and incorporated herein by reference in their entireties). Stabilized lithium metal powder has a significantly reduced reaction with moisture and air.

The lithium metal powder may also be alloyed with a metal. For example, the lithium metal powder may be alloyed with a Group 1-VIII element. Suitable elements from Group IB may include, for example, silver or gold. Suitable elements from Group IIB may include, for example, zinc, cadmium, or mercury. Suitable elements from Group IIA of the Periodic Table may include beryllium, magnesium, calcium, strontium, barium, and radium. Elements from Group IIIA that may be used in the present invention may include, for example, boron, aluminum, gallium, indium, or thallium. Elements from Group IVA that may be used in the present invention may include, for example, carbon, silicon, germanium, tin, or lead. Elements from Group VA that may be used in the present invention may include, for example, nitrogen, phosphorus, or bismuth. Suitable elements from Group VIIIB may include, for example, palladium, or platinum.

The polymer binder for the printable lithium composition is selected so as to be compatible with the lithium metal powder. “Compatible with” or “compatibility” is intended to convey that the polymer binder does not violently react with the lithium metal powder resulting in a safety hazard. The lithium metal powder and the polymer binder may react to form a lithium-polymer complex, however, such complex should be stable at various temperatures. It is recognized that the amount (concentration) of lithium and polymer binder contribute to the stability and reactivity. The polymer binder may have a molecular weight of about 1,000 to about 8,000,000, and often has a molecular weight of 2,000,000 to 5,000,000. Suitable polymer binders may include one or more of poly(ethylene oxide), polystyrene, polyisobutylene, natural rubbers, butadiene rubbers, styrene-butadiene rubber, polyisoprene rubbers, butyl rubbers, hydrogenated nitrile butadiene rubbers, epichlorohydrin rubbers, acrylate rubbers, silicon rubbers, nitrile rubbers, polyacrylic acid, polyvinylidene chloride, polyvinyl acetate, ethylene propylene diene termonomer, ethylene vinyl acetate copolymer, ethylene-propylene copolymers, ethylene-propylene terpolymers, polybutenes. The binder may also be a wax. Preferably the binder is added as a dry powder.

The rheology modifier is selected so as to be compatible with the lithium metal powder and the polymer binder and dispersible in the composition. In one embodiment, the rheology modifier is carbon-based. For example, the rheology modifier may be comprised of carbon nanotubes to provide a structure for a coated electrode. In another embodiment, carbon black may be added as a rheology modifier.

A preferred embodiment of the printable lithium composition includes a carbon-based rheology modifier such as carbon nanotubes. Use of carbon nanotubes may also provide a three-dimensional support structure and conductive network for a lithium anode when coated with the printable lithium composition and increase its surface area. Another support structure may be one as described by Cui et al. [Science Advances, Vol. 4, no. 7, page 5168, DOI: 10.1126/sciadv.aat5168], incorporated herein by reference in its entirety, which uses a hollow carbon sphere as a stable host that prevents parasitic reactions, resulting in improved cycling behavior. Yet another support structure may be a nanowire as described in U.S. Pat. No. 10,090,512 incorporated herein by reference in its entirety. Other compatible carbon-based rheology modifiers include carbon black, graphene, graphite, hard carbon and mixtures or blends thereof.

Other examples of suitable rheology modifiers may include non-carbon-based materials, including titanium oxides and silicon oxides. For example, silicon nanostructures such as nanotubes or nanoparticles may be added as a rheology modifier to provide a three-dimensional structure and/or added capacity. The rheology modifiers may also increase the durability of the layer (i.e., coating, foil or film) formed from the printable lithium composition by preventing mechanical degradation and allow for faster charging.

Additional rheology modifiers may be added to the composition to modify properties such as viscosity and flow under shear conditions. The rheology modifier may also provide conductivity, improved capacity and/or improved stability/safety depending on the selection of the rheology modifier. To this end, the rheology modifier may be the combination of two or more compounds so as to provide different properties or to provide additive properties. Exemplary rheology modifiers may include one or more of silicon nanotubes, fumed silica, titanium dioxide, zirconium dioxide and other Group IIA, IIIA, IVB, VB and VIA elements/compounds and mixtures or blends thereof. Other additives intended to increase lithium ion conductivity can be used; for example, electrochemical device electrolyte salts such as lithium perchlorate (LiCO₄), lithium hexafluorophosphate (LiPF₆), lithium difluoro(oxalate)borate (LiDFOB), lithium tetrafluoroborate (LiBF₄), lithium nitrate (LiNO₃), lithium bis(oxalate) borate (LiBOB), lithium trifluoromethanesulfonimide (LiTFSI), lithium bis(fluorosulfonyl) imide (LiFSI).

In general, the lithium metal powder in the printable lithium composition may be dispersed uniformly with the dry electrode active and inactive components using dispersion/mixing techniques known to those skilled in the art. During the lamination of the dry powder to the current collector the lithium metal powder is brought into intimate contact with the active anode material. Upon electrolyte addition, the lithium metal powder will react with the anode active producing a lithiated compound. The space where the lithium metal powder particle once resided will become partially vacant resulting in a porous structure. Higher concentration of lithium metal powder will result in a more porous structure. Rheology modifiers may be included in the printable lithium formulation to modify the porosity and overall three-dimensional support structure as desired. Examples of such modifiers may include carbon nanotubes (CNTs), graphene or polyacrylate as described in Electrochemical and Solid-State Letters, 12, 5, A107-A110, 2009.

Solvents if used should be compatible with lithium and may include in one embodiment non-polar solvents such as acyclic hydrocarbons, cyclic hydrocarbons, aromatic hydrocarbons, symmetrical ethers, unsymmetrical ethers, cyclic ethers, alkanes, sulfones, mineral oil, and mixtures, blends or cosolvents thereof. Examples of suitable acyclic and cyclic hydrocarbons include n-hexane, n-heptane, cyclohexane, and the like. Examples of suitable aromatic hydrocarbons include toluene, ethylbenzene, xylene, isopropylbenzene (cumene), and the like. Examples of suitable symmetrical, unsymmetrical and cyclic ethers include di-n-butyl ether, methyl t-butyl ether, tetrahydrofuran, glymes and the like. Commercially available isoparaffinic synthetic hydrocarbon solvents with tailored boiling point ranges such as Shell Sol® (Shell Chemicals) or Isopar® (Exxon) are also suitable.

The polymer binder and solvents are selected to be compatible with each other and with the lithium metal powder. In general, the binder or solvent should be non-reactive with the lithium metal powder or in amounts so that any reaction is kept to a minimum and violent reactions are avoided. The binder and solvent should be compatible with each other at the temperatures at which the printable lithium composition is made and will be used. In one embodiment, the solvent is low in hygroscopicity in that there is a minimum attraction of moisture in the air. Non-polar solvents are thus well-suited for the invention. In contrast, polar solvents have a high hygroscopicity and have reactivity and non-compatibility with the binder, and particularly with the lithium metal. Polar solvents like N-methyl 1,2 pyrrolidone (NMP) and gamma-butyrolactone (GBL) should be avoided due to their being highly reactive with lithium leading to run away and potentially catastrophic pyric reactions. Preferably the solvent (or co-solvent) will have sufficient volatility to readily evaporate from the printable lithium composition (e.g., in slurry form) to provide drying of the printable lithium composition (slurry) after application and to provide the electrode material in dry form.

In another embodiment, a mixture of the polymer binder, rheology modifier, coating reagents, and other potential additives for the lithium metal powder may be formed and introduced to contact the lithium droplets during dispersion at a temperature above the lithium melting point, or at a lower temperature after the lithium dispersion has cooled such as described in U.S. Pat. No. 7,588,623 the disclosure of which is incorporated by reference in its entirety. The thusly modified lithium metal may be introduced in a dry powder form or in a solution form in a solvent of choice. It is understood that combinations of different process parameters could be used to achieve specific coating and lithium powder characteristics for particular applications.

The components of the printable lithium composition may be mixed together as a slurry or paste to have a high concentration of solid. Dry lithium powder may be dispersed by standard techniques, the selection of which may be made by one skilled in the art. Thus, the slurry/paste may be in the form of a concentrate with not all of the solvent necessarily added prior to the time of depositing or applying. In one embodiment, the lithium metal powder may be uniformly suspended along with any rheology modifiers in the solvent so that when applied or deposited a substantially uniform distribution of lithium metal powder is deposited or applied. In a substantially uniform distribution of the lithium metal powder, the powder may be suspended in the solvent such that there is no qualitative variation in lithium metal powder content from top to bottom of the suspension

Embodiments of the printable lithium composition in accordance with the present invention may accommodate high binder ratios, including up to 20% on a dry basis. Various properties of the printable lithium composition, such as viscosity and flow, may be modified by increasing the binder and modifier content up to 50% dry basis without loss of electrochemical activity of lithium. Increasing the binder content facilitates the loading of the printable lithium composition and the flow during the dry application (coating) process. The printable lithium composition may comprise between about 50% to about 98% by weight of lithium metal powder and about 2% to about 50% by weight of polymer binder and rheology modifiers on a dry weight basis. In one embodiment, the printable lithium composition comprises between about 60% to about 90% by weight lithium metal powder and between about 10% to about 40% by weight of polymer binder and rheology modifiers.

An important aspect of printable lithium compositions is the rheological stability of the suspension. Because lithium metal has a low density of 0.534 g/cc, it is difficult to prevent lithium powder from separating from solvent suspensions. By selection of lithium metal powder loading, polymer binder and conventional modifier types and amounts, viscosity and rheology may be tailored to create the stable suspension of the invention. A preferred embodiment shows no separation at greater than 90 days. This may be achieved by designing compositions with zero shear viscosity in the range of 1×10⁴ cps to 1×10⁷ cps, wherein such zero shear viscosity maintains the lithium in suspension particularly when in storage. When shear is applied, the suspension viscosity decreases to levels suitable for use in printing or coating applications.

The resulting printable lithium composition preferably may have a viscosity at 10 s⁻¹ about 20 to about 20,000 cps, and sometimes a viscosity of about 100 to about 2,000 cps, and often a viscosity of about 700 to about 1,100 cps. At such viscosity, the printable lithium composition is a flowable suspension or gel. The printable lithium composition preferably has an extended shelf life at room temperature and is stable against metallic lithium loss at temperatures up to 60° C., often up to 120° C., and sometimes up to 180° C. The printable lithium composition may separate somewhat over time but can be placed back into suspension by mild agitation and/or application of heat.

In one embodiment, the lithium metal powder of prelithiation agent prior to mixing with the active component comprises on a solution basis about 0.5 to about 100%, preferably about 0.5% to about 50%, more preferably about 10 to 30%. The lithium metal powder may be added to the active component by itself with no other additives. In another embodiment, the printable lithium composition prior to mixing with the active component comprises on a solution basis about 0.0 to about 20% polymer binder, preferably about from 0.1% to 10%, most preferably from about 0.1% to about 5%. In another embodiment, the printable lithium composition prior to mixing with the active component comprises on a solution basis about 0.0 to about 20% rheology modifier, preferably about from 0.1% to 10%, most preferably from about 0.5% to about 5%. In another embodiment, the printable lithium composition prior to mixing with the active component comprises on a solution basis about 0% to about 95% solvent, preferably about from 40% to 95%, most preferably from about 65% to about 90%.

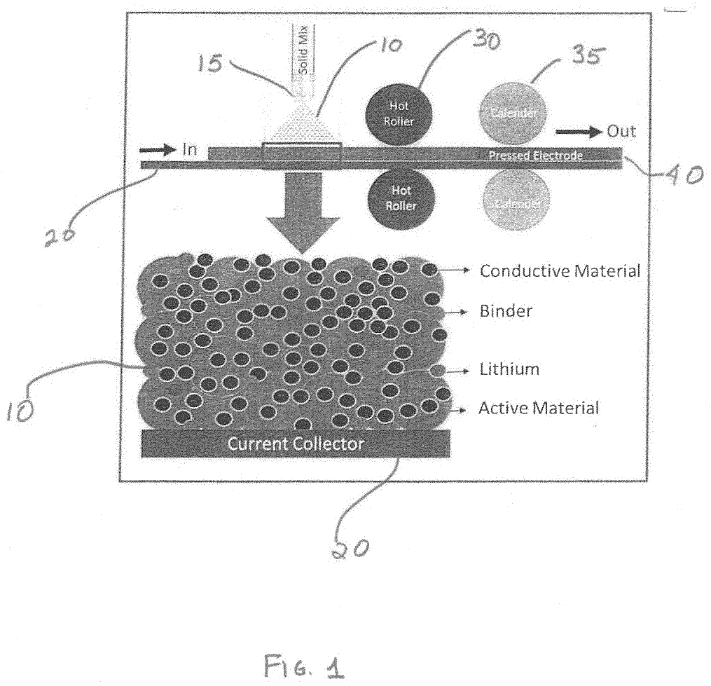

Referring to FIG. 1, in one embodiment the process for manufacturing an electrode may entail depositing the dry electrode mixture 10 of the active component (active electrode material, a binder and conductive material) and the printable lithium composition via a nozzle 15. The thickness of the deposited dry electrode mixture on the substrate 20 (e.g. shown as a current collector) may be controlled using a template (not shown). The dry electrode mixture 10 may be pressed onto the substrate 20 using rollers 30 followed by a calendar 35 to form the electrode 40.

In one embodiment, the active anode material and the printable lithium composition are provided together and deposited onto the current collector (e.g., copper, nickel, etc.). For instance, the active anode material and printable lithium composition may be mixed and deposited together. In one embodiment, a Bühler continuous mixer may be employed. In another embodiment, the active anode material and the printable lithium composition are co-extruded to form a layer of the printable lithium composition on the substrate (e.g., the current collector for an anode or on the solid electrolyte of a solid-state battery). The deposition of the printable lithium composition including the above extrusion technique may include depositing as wide variety patterns (e.g., dots, stripes), thicknesses, widths, etc. For example, the printable lithium composition and active anode material may be deposited as a series of stripes, such as described in US Publication No. 2014/0186519 incorporated herein by reference in its entirety. The stripes would form a 3D structure that would account for expansion of the active anode material during lithiation. For example, silicon may expand by 300 to 400% during lithiation. Such swelling potentially adversely affects the anode and its performance. By depositing the printable lithium as a thin stripe in the Y-plane as an alternating pattern between the silicon anode stripes, the silicon anode material can expand in the X-plane alleviating electrochemical grinding and loss of particle electrical contact. Thus, the printing method can provide a buffer for expansion. In another example, where the printable lithium formulation is used to form the anode, it could be co-extruded in a layered fashion along with the cathode and separator, resulting in a solid-state battery.

In additional embodiments, at least a portion of the printable lithium composition can be supplied to the anode active material prior to the formation process of the battery. For example, the anode may comprise a partially lithium-loaded silicon-based active material as described in US Publication No. 2018/0269471 herein incorporated by reference in its entirety, in which the partially loaded active material has a selected degree of loading of lithium through intercalation/alloying or the like. In some embodiments, the anode active material may be mechanically lithiated with a printable lithium composition. For example, the anode active material may be pressed with force selected to induce mechanical lithiation once a printable lithium composition is applied on its surface.

Hereinafter, the preferred Examples and Comparative Examples of the present invention will be described. However, the following Examples are only a preferred exemplary embodiment of the present invention and the present invention is not limited thereto. The Examples provide illustration of the formation of coin cells and larger pouch cells.

### EXAMPLES

### Example 1

85% Graphite, 5% carbon black, and 10% PVDF are dry mixed in a THINKY ARE 250 planetary centrifugal mixer at 1000 rpm for 5 minutes. A 10% printable lithium composition from Livent USA Corp. as Liovix™ and having a lithium equivalence of about 20% of the total anode capacity is added in, and mixed for another 1 minute in the THINKY ARE 250 planetary centrifugal mixer. The resulting dry mixture is deposited on a polymer-coated copper substrate and pressed at 160° C., 15000 PSI non-polar.

### Example 2

85% of a Graphite/10% silicon oxide mixture, 5% carbon black and 10% PVDF are dry mixed in a THINKY ARE 250 planetary centrifugal mixer at 1000 rpm for 5 minutes. A 10% printable lithium composition available from Livent USA Corp. as Liovix™ and having a lithium equivalence of about 20% of the total anode capacity is added in and mixed for another 1 minute in the THINKY ARE 250 planetary centrifugal mixer. The resulting dry mixture is deposited on a polymer-coated copper substrate and pressed at 160° C., 15000 PSI.

### Example 3

85% of a Graphite/25% silicon oxide mixture, 5% carbon black and 10% PVDF are dry mixed in a THINKY ARE 250 planetary centrifugal mixer at 1000 rpm for 5 minutes. A 10% printable lithium composition available from Livent USA Corp. as Liovix™ and having a lithium equivalence of about 20% of the total anode capacity is added in and mixed for another 1 minute in the THINKY ARE 250 planetary centrifugal mixer. The resulting dry mixture is deposited on a polymer-coated copper substrate and pressed at 160° C., 15000 PSI.

After drying and calendering, the electrodes of Examples 1-3 are assembled into a half cell in the coin cell format with a lithium metal counter electrode (Graphite/Cellgard 3501/Li half-cell) using 1M LiPF₆ in EC:FEC:EMC:DMC 1:1:2:6 (volume ratio) electrolyte. The cell is tested with the following protocol on a Maccor series 4000 cycler: 1) rest 24 hrs @ 45° C., 2) discharge at 1.5 C to 0.005V, 3) a constant voltage step until current drop to 0.01 C, and 4) charge at 0.1 C to 1.5V.

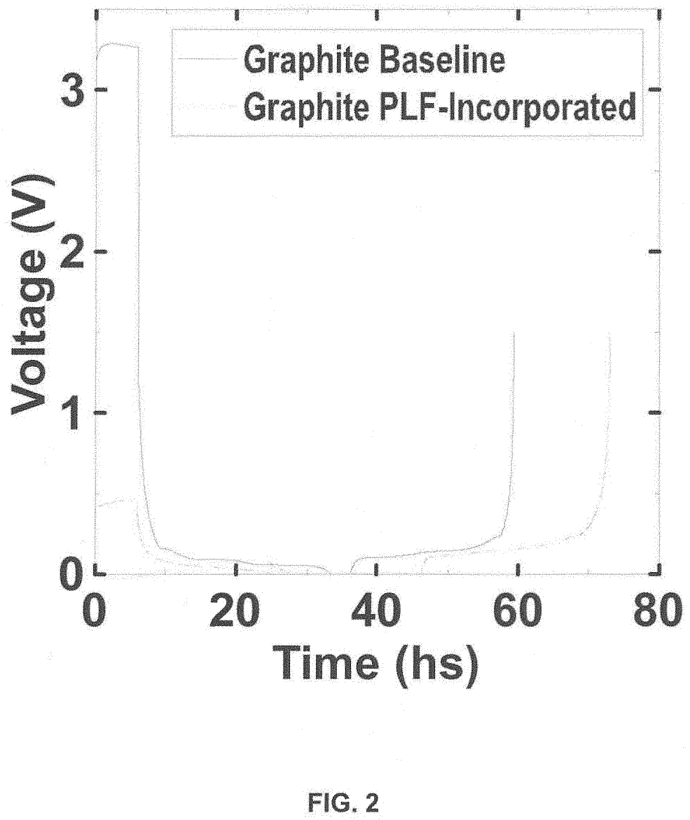

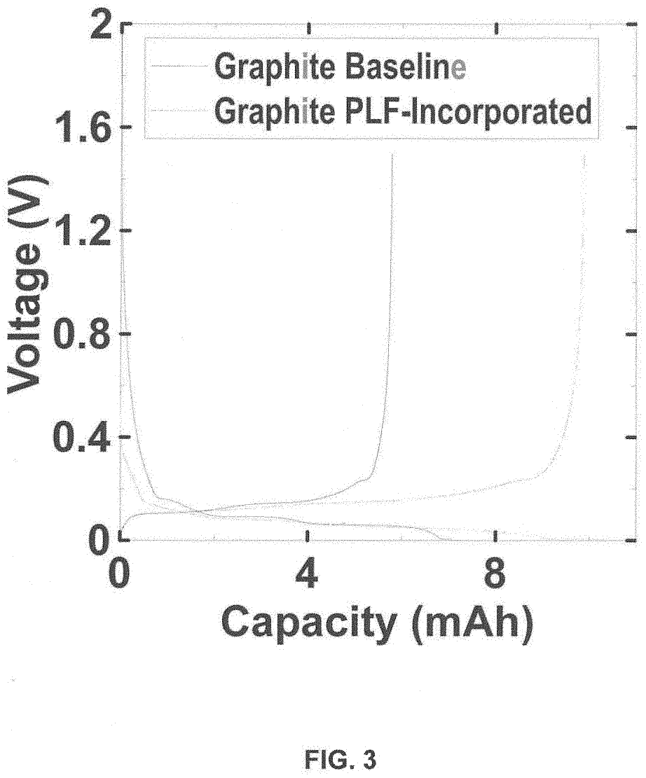

FIGS. 2 and 3 illustrate the voltage curves for baseline cells and cells with a printable lithium composition incorporated according to Examples 1. The voltage curves demonstrate that cells with a printable lithium composition incorporated have a lower starting open circuit voltage, which indicates the electrode is partially lithiated by the printable lithium composition. The difference between the average charge and discharge voltage is lower for cells with a printable lithium composition incorporated compared to baseline cells and indicates lower DC resistance.

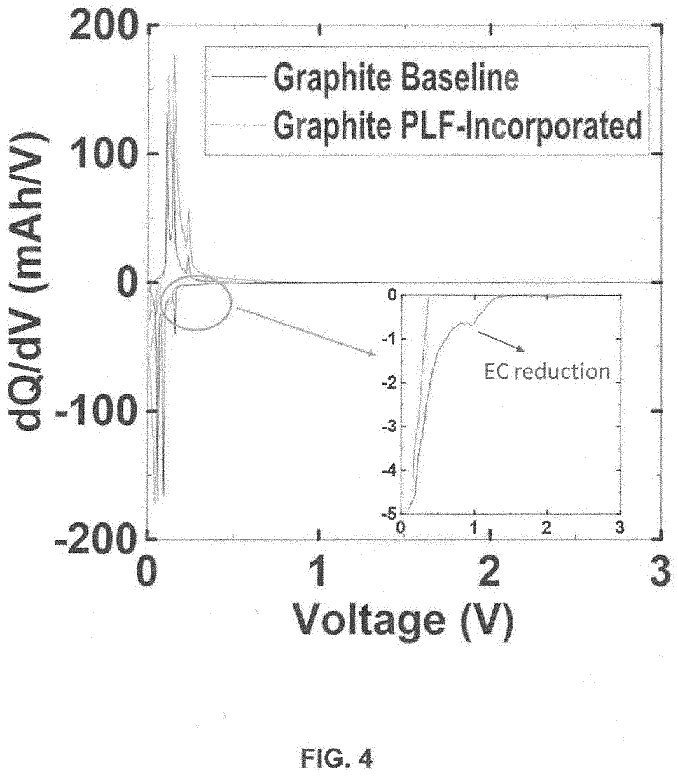

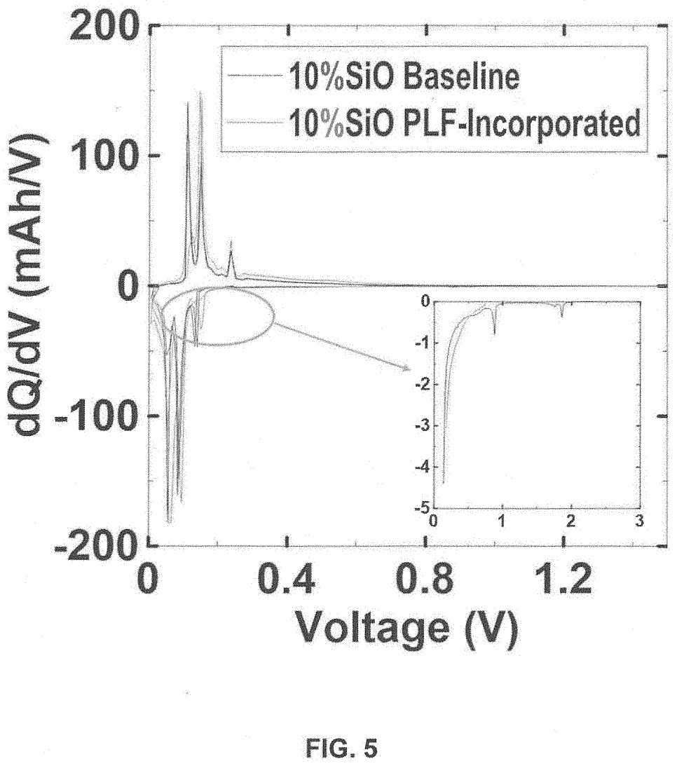

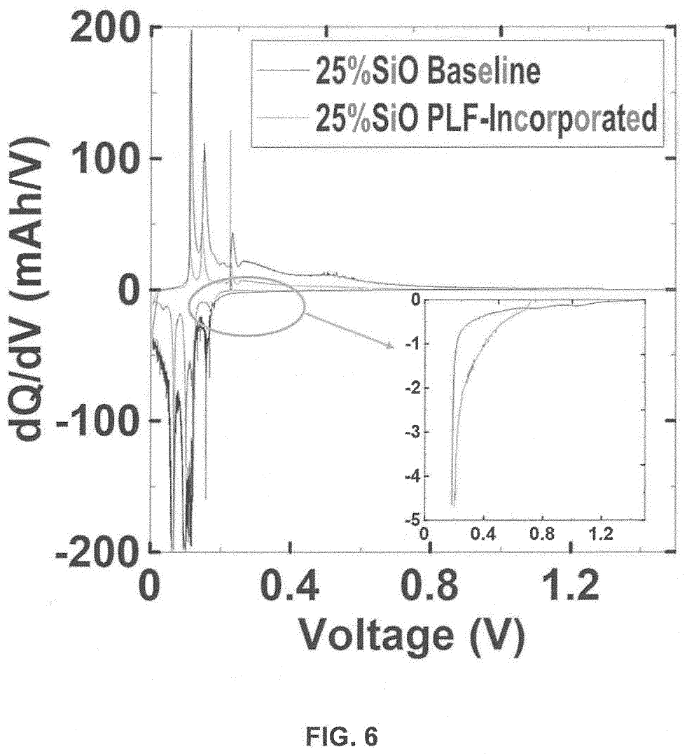

FIGS. 4-6 are plots comparing the differential capacity (dQ/dV) versus potential (V) between baseline and cells with a printable lithium composition incorporated according to Examples 1 to 3 respectively during the first charge. Electrochemical results are similar to results for electrodes produced using the conventional approach. As seen in FIGS. 4-6, incorporation of a printable lithium composition eliminates the electrolyte solvent reduction peak since formation of the solid electrolyte interface has taken place within 24 hours of applying the dry electrode material mixture to the substrate.

TABLE 2
Performance Comparison between Baseline Cells and Cells
with Printable Lithium Composition (Example 1)

| Cell | First CE % | Average First CE % |
|---|---|---|
| Baseline Cell 1 | 81.7 | 84.0 ± 3.6 |
| Baseline Cell 1 | 89.0 | |
| Baseline Cell 1 | 81.2 | |
| Printable Lithium | 96.0 | 95.8 ± 0.2 |
| incorporated 1 | | |
| Printable Lithium | 95.8 | |
| Incorporated 2 | | |
| Printable Lithium | 95.5 | |
| Incorporated 3 | | |

Table 2 provides a comparison of first cycle efficiencies between baseline cells and cells with a printable lithium composition incorporated according to Example 1. As seen in Table 2, the first cycle efficiency (CE) for baseline cells averages about 84.0% whereas the first CE for cells with a printable lithium composition is about 95.8% on average, representing about a 12% increase.

TABLE 3
Performance Comparison between Baseline Cells and Cells with Printable
Lithium Composition in Graphite-10% SiO/Li half cells (Example 2)
Table 2 provides a comparison of first cycle efficiencies between
baseline cells and cells with a printable lithium composition
incorporated according to Example 2.

| Cell | First CE % | Average First CE % |
|---|---|---|
| Baseline Cell 1 | 77.6 | 78.0 ± 0.5 |
| Baseline Cell 2 | 78.3 | |
| Printable Lithium | 85.9 | 86.3 ± 0.6 |
| Incorporated 1 | | |
| Printable Lithium | 96.7 | |
| Incorporated 2 | | |

As seen in Table 3 the first cycle efficiency (CE) for baseline cells averages about 78.0% whereas the first CE for cells with a printable lithium composition incorporated is about 86.3% on average, representing about an 8.3% increase.

TABLE 4
Performance Comparison Between Baseline Cells and Cells with Printable
Lithium Composition in Graphite-25% SiO/Li half cells (Example 3)
Table 4 provides a comparison of first cycle efficiencies between
baseline cells and cells with a printable lithium composition
incorporated according to Example 3.

| Cell | First CE % | Average First CE % |
|---|---|---|
| Baseline Cell 1 | 64.5 | 64.6 ± 0.1 |
| Baseline Cell 2 | 64.7 | |
| Printable Lithium | 76.3 | 76.4 ± 0.1 |
| Incorporated 1 | | |
| Printable Lithium | 76.5 | |
| Incorporated 2 | | |

As seen in Table 4, the first cycle efficiency (CE) for baseline cells averages about 64.6% whereas the first CE for cells with a printable lithium composition incorporated is about 76.4% on average, representing about a 11.8% increase.

### Example 4

In order to demonstrate the ability to scale up the process of the invention, pouch cells were made. The dry mixture of Example 1 was deposited on the polymercoated copper substrate and pressed at 160° C., 15000 PSI to form a pouch cell having the dimension of 4.6 cm by 4.3 cm.

After drying and calendering, the electrode of Example 4 is assembled into a half cell in the pouch cell format with a lithium metal counter electrode (Graphite/Cellgard 3501/Li half-cell) and with 1M LiPF₆ in EC:FEC:EMC:DMC 1:1:2:6 (volume ratio) electrolyte. The cell is tested with the following protocol on a Maccor series 4000 cycler: 1) rest 24 hrs @ 45° C., 2) discharge at 1.5 C to 0.005V, 3) a constant voltage step until current drop to 0.01 C, and 4) charge at 0.1 C to 1.5V.

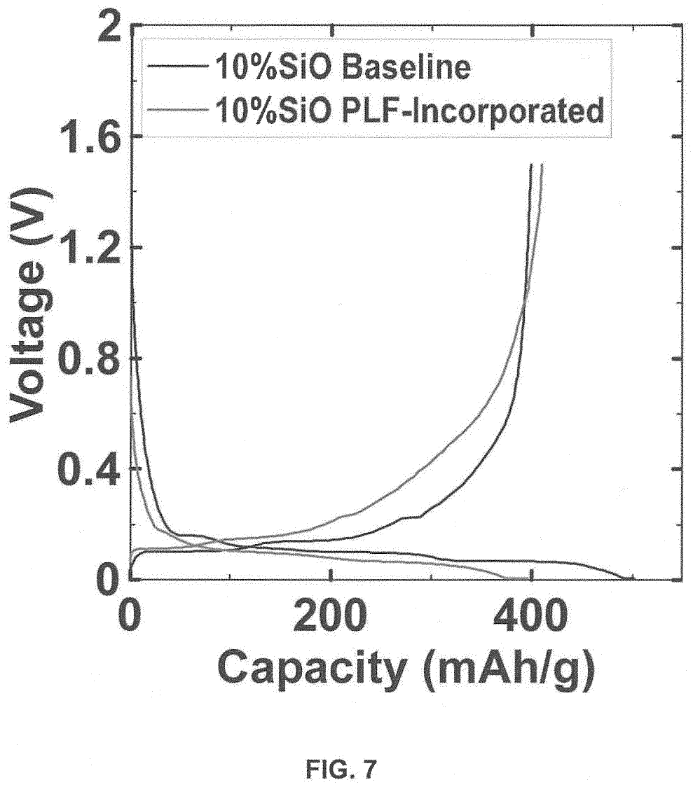

FIG. 7 illustrates the voltage curve for baseline pouch cells and cells with the printable lithium position incorporated according to Example 4.

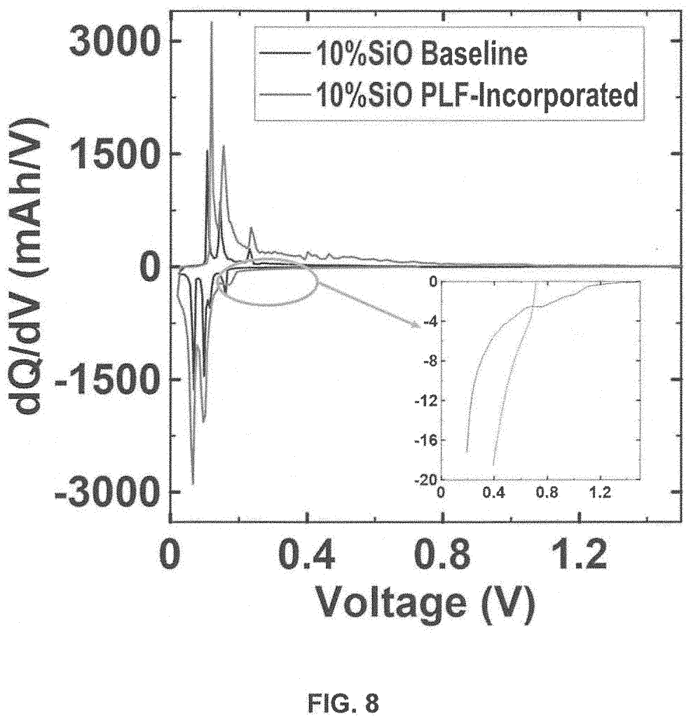

FIG. 8 is a plot comparing the differential capacity (dQ/dV) versus potential (V) between baseline and cells with a printable lithium composition incorporated according to Example 4. The voltage curve demonstrates that cells with a printable lithium composition incorporated have a lower starting open circuit voltage, which indicates the electrode is partially lithiated by the printable lithium composition.

TABLE 5
Performance Comparison Between Baseline Cells and Cells
with Printable Lithium Composition (Example 4)

| Cell | First CE % | Average First CE % |
|---|---|---|
| Baseline Cell 1 | 78.0 | 78.8 ± 1.1 |
| Baseline Cell 2 | 79.5 | |
| Printable Lithium | 87.4 | 90.4 ± 4.2 |
| Incorporated 1 | | |
| Printable Lithium | 93.4 | |
| Incorporated 2 | | |

This data confirms an increase of 11.6 percent that the process of the present invention may be scaled up to a larger commercial scale from the coin cells.

Although the present approach has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present approach.

That which is claimed is:

1. A dry process for forming a prelithiated electrode comprising:
preparing a dry electrode material mixture comprising
a) an active component comprising an active electrode material, a binder and a conductive material mixed with
b) a prelithiation printable lithium composition comprising a lithium metal powder, a polymer binder compatible with the lithium metal powder, and a rheology modifier compatible with the lithium metal powder to form a dry electrode material mixture; and
depositing the dry electrode material mixture to a substrate as a non self-supported layer or interface to form a prelithiated electrode.

2. The process of claim 1, wherein applying the dry electrode material mixture to the substrate comprises depositing the dry electrode material mixture onto the substrate to form the non self-supported layer.

3. The process of claim 2, wherein depositing the dry electrode material mixture to the substrate is performed by a method selected from the group consisting of extruding, roll compaction, electrostatic deposition and combinations thereof.

4. The process of claim 1, wherein the substrate is treated with an adhesion promoting agent.

5. The process of claim 1, wherein the adhesion promoter is selected from the group consisting of unsaturated elastomers, saturated elastomers, thermoplastics, polyacrylic acid, polyvinylidene chloride, and polyvinyl acetate. poly(ethylene oxide), polystyrene, polyisobutylene, natural rubbers, butadiene rubbers, styrene-butadiene rubber, polyisoprene rubbers, butyl rubbers, hydrogenated nitrile butadiene rubbers, epichlorohydrin rubbers, acrylate rubbers, silicon rubbers, nitrile rubbers, polyacrylic acid, polyvinylidene chloride, polyvinyl acetate, ethylene propylene diene termonomer, ethylene vinyl acetate copolymer, ethylene-propylene copolymers, ethylene-propylene terpolymers, polybutenes, wax and combinations thereof.

6. The process of claim 1, wherein applying the dry electrode material mixture to the substrate comprises pressing the dry electrode material mixture onto the substrate at a temperature between about 80 and about 180° C. and at a pressure between about 5000 and about 50000 PSI.

7. The process of claim 1, wherein the substrate is selected from the group consisting of a current collector, a polymer film and solid electrolytes.

8. The process of claim 1, wherein the active electrode material is an active anode material.

9. The process of claim 8, wherein the active anode material comprises a carbon-based material is selected from the group consisting of graphite, carbon black, hard carbon, carbon alloys, and combinations thereof.

10. The process of claim 8, wherein the active anode material is selected from the group consisting of graphite-SiOx composites, SiO, SiO₂, Si powder, SiC, Si/C composites, Si-based alloys, graphite-SnO, Sn/C composites, and combinations thereof.

11. The process of claim 1, wherein the active electrode material is an active cathode material.

12. The process of claim 11, wherein the active cathode material is a non-lithiated material selected from the group consisting of MnO₂, V₂O₅, MoS₂, metal fluorides, sulfur, sulfur composites, tin and combinations thereof.

13. The process of claim 1, wherein the printable lithium composition comprises on a solution basis between about 0.5% to about 50% by weight of the lithium metal powder and between about 0.1% to about 20% by weight of the polymer binder and of the rheology modifier.

14. The process of claim 13, wherein the printable lithium composition comprises on a solution basis between about 10% to about 30% by weight of the lithium metal powder, between about 0.1% to about 5% by weight of the polymer binder, and between about 0.5% to about 5% of the rheology modifier.

15. The process of claim 1, wherein the lithium metal powder is stabilized lithium metal powder.

16. The process of claim 1, wherein the rheology modifier is a conductive material.

17. The process of claim 16, wherein the conductive material is selected from the group consisting of carbon black, carbon nanotubes, and graphene.

18. The process of claim 1, wherein the rheology modifier provides improved capacity and is electrochemically active.

19. The process of claim 18, wherein the rheology modifier that provides improved capacity is selected from the group consisting of silicon nanotubes, graphite, hard carbon, and graphene.

20. The process of claim 1, wherein the rheology modifier provides improved stability.

21. The process of claim 1, wherein the rheology modifier is selected from the group consisting of carbonaceous materials, silicon-containing materials, tin-containing materials, Group IIA oxides, Group IIIA oxides, Group IVB oxides, Group VB oxides and Group VIA oxides.

22. The process of claim 21, wherein the carbonaceous material is selected from the group consisting of carbon black, carbon nanotubes, graphite, hard carbon, and graphene.

23. The process of claim 1, which is essentially solvent free.

24. The process of claim 1, which is a one-step process.

25. The process of claim 1, wherein the temperature of the process is below the melting point of lithium.

26. A prelithiated electrode produced by the process of claim 1.

27. The process of claim 21, wherein the silicon-containing material is selected from the group consisting of silicon nanotubes and fumed silica.

28. The process of claim 1, wherein the polymer binder has a molecular weight of 1,000 to 8,000,000 and is selected from the group consisting of unsaturated elastomers, saturated elastomers, thermoplastics, polyacrylic acid, polyvinylidene chloride, and polyvinyl acetate.

29. The process of claim 28, wherein the unsaturated elastomer is selected from the group consisting of butadiene rubber, isobutylene, and styrene butadiene rubber.

30. The process of claim 28, wherein the saturated elastomer is selected from the group consisting of ethylene propylene diene monomer rubber and ethylene-vinyl acetate.

31. The process of claim 28, wherein the thermoplastic is selected from the group consisting of polystyrene, polyethylene and polymers of ethylene oxide.

32. The process of claim 31, wherein the polymers of ethylene oxide is selected from the group consisting of poly(ethylene glycol) and poly(ethylene oxide).

33. The process of claim 1 further including forming a solid electrolyte interface layer within 24 hours after applying the dry electrode material mixture to the substrate.

34. A battery having a cathode and an anode formed from the process of claim 1.

35. A battery of claim 34, wherein the battery has a first cycle efficiency greater than about 80%.

36. The battery of claim 34, wherein the first cycle efficiency is greater than 90%.

37. A pre-lithiated electrode produced by the process of claim 1.

38. A electrode material mixture comprising
a) an active component comprising an active electrode material, a binder and a conductive material mixed with
b) a prelithiation printable lithium composition comprising a lithium metal powder, a polymer binder compatible with the lithium metal powder, and a rheology modifier compatible with the lithium metal powder to form a dry electrode material mixture, wherein the dry electrode material mixture has less than about 20 percent solvent content.

39. The electrode material according to claim 38, where the dry electrode material has less than about 10 percent solvent content.

40. The electrode material according to claim 38, where the dry electrode material has less than about 1 percent solvent content.

41. A prelithiated electrode comprising:
a) an electrode substrate and
b) a dry electrode material mixture applied to the electrode substrate as a layer or interface, the dry electrode mixture comprising an active component comprising an active electrode material, a binder and a conductive material mixed with a prelithiation lithium composition comprising a lithium metal powder, a polymer binder compatible with the lithium metal powder, and a rheology modifier compatible with the lithium metal powder, wherein the dry electrode mixture on the electrode substrate is essentially free of solvent.

42. A battery comprising the prelithiated electrode of claim 41.
